(19) United States
(12) Patent Application Publication
(10) Pub. No.: US 2001/0027493 A1
(43) Pub. Date: Oct. 4, 2001

(54) Method for providing streaming media data in a network-based environment

(76) Inventor: Christopher Ryall Wallace, San Francisco, CA (US)

Correspondence Address: WILSON SONSINI GOODRICH & ROSATI, 650 PAGE MILL ROAD, PALO ALTO, CA, 943041050

(21) Appl. No.: 09/728,434

(22) Filed: Dec. 1, 2000

Related U.S. Application Data
(60) Provisional application No. 60/168,917, filed on Dec. 3, 1999.

(51) Int. Cl. G06F 15/16

(52) U.S. Cl. 709/247

(57) ABSTRACT

A method for providing streaming media data over coupled public/private and highly trafficked computer networks is described. By distributing media servers and aggregating media data at strategic locations, a streaming data subscription services are enabled that offer desktop video and other media with a quality of service exceeding what is presently available with provider-user data transfers directly over the public Internet.

### CROSS REFERENCE TO RELATED APPLICATION

This Application claims the benefit of U.S. Provisional Application Ser. No. 60/168,917, filed Dec. 3, 1999. Further, the entirety of application Ser. No. 60/168,917 is incorporated herein by reference.

### BACKGROUND OF THE INVENTION

1. Field of the Invention

The present invention relates to providing streaming media data over coupled and heavily trafficked public/private computer networks. More particularly, the present invention relates to architectures for server deployment that reduce problems associated with the public network usage that otherwise impede efficient data subscription services to users.

2. Description of Related Art

The number of computers connected to the Internet has grown tremendously in recent years. A client/server description of the interactions between computers is well-known. A “client” computer connected to the Internet can download digital information from “server” computers. Client application software typically accepts commands from a user and obtains data and services by sending requests to server applications running on the server computers. A number of protocols may be used to exchange commands and data between computers connected to the Internet. For instance, protocols including the File Transfer Protocol (FTP), the Hyper Text Transfer Protocol (HTTP), the Simple Mail Transfer Protocol (SMTP), and the Gopher document protocol are commonly used.

Typically, the HTTP protocol is used to access data on the World Wide Web (the Web). The Web is an information service on the Internet providing documents and information, as well as links between documents and information. It is made up of numerous Web sites located around the world that maintain and distribute electronic documents. A Web site may use one or more Web server computers that store and distribute documents in a number of formats, including the Hyper Text Markup Language (HTML). An HTML document contains text and metadata (commands providing formatting information), as well as embedded links that reference other data or documents. The referenced documents may represent text, graphics, video, streaming-media or any combination thereof.

A Web browser is a client application or, preferably, an integrated operating system utility that communicates with server computers via FTP, HTTP and Gopher protocols. Web browsers retrieve electronic documents from the network and present them to a user. Web browsers receive content from a server sent over the Internet that is typically encoded in Hyper Text Markup Language (HTML) and executed by the browser on a client computer. To remove limitations imposed by using only HTML scripts, browsers typically support the usage of additional components such as Java Applets, ActiveX Controls, and Plug-Ins that provide extra functionality. These additional components, commonly referred to as “client bits,” are typically stored as executables in the memory of the client computer, and can be installed onto the client computer directly from a storage medium or downloaded from a server over the Internet. The functional components such as Java Applets, ActiveX Controls, and Plug-Ins are mapped into the script so that actions, methods, or properties of an object can be called therefrom. (ActiveX Controls are reusable software components that incorporate ActiveX technology, which enables software applications to interact with one another in a networked environment regardless of the language in which the components were created. ActiveX Controls can be embedded in Web pages to produce animation and other multimedia effects, interactive objects and sophisticated applications. ActiveX Controls can be written in a variety of programming languages, including C, C++, Visual Basic, and Java. A Plug-In, on the other hand, is a software component designed to plug into the Netscape Navigator browser, and to permit the browser to access and execute files embedded in HTML documents that are in formats the browser normally would not normally recognize.).

Web browsers typically contain an associated scripting space, which is memory space allocated for a browser instance, for the reception of electronic data called a script. Web browsers receive scripts from the network into the scripting space and execute instructions contained in the script. One such instruction contained in a script might be presenting data to a user, usually by way of an output device such as a computer monitor. In addition to data for presentation to a user, the script may also contain mappings to objects and services stored in the memory of a client computer and instructions for interaction with or communication to and from those objects and services. A script might also contain additional instructions as well. An exchange between script instructions in a scripting space and a service or an object can be facilitated by additional objects, such as a Plug-In or ActiveX control. In these cases, a mapping to the Plug-In or ActiveX control is contained in the script, and the Plug-In or ActiveX control performs some operation towards carrying out the script instruction.

Through such technology, the Web or Internet has become a major communication medium wherein large volumes of streaming media, such as video presentation, are provided to users on a daily basis. Streaming media is a rich and powerful means of information delivery, which has clear advantages in the business environment. The power of video, combined with the ubiquity of the Internet, offers businesses a robust new platform for communication and collaboration. In today's global economy, streaming enables businesses to gain competitive advantage.

To date, however, the transmission of video over the Internet has been plagued by the “watch and wait” phenomenon. Previous IP video technology required that viewers first download a segment in its entirety before playback could begin. As a result, currently available streaming media applications generally suffer from degradation in the quality of service (QoS) as applied to networked environments (e.g., Internet). The degradation in quality of service (QoS) is generally attributable to network congestion and data capacity limitations in communication links and conduits (e.g., connectivity), as well as other factors that generally affect quality of service (QoS). As a result, in current streaming media applications as applied to networked environments, the end user or client typically will experience degradation in the quality of the particular media application. Typical problems associated with such degraded media applications are a loss in sound quality, picture quality, or actual operation of the media application at the end user's interface that is attributable to transmission congestion. Therefore, as streaming media becomes a more widely employed and accepted communication medium, quality of service (QoS) considerations are becoming an increasingly important factor in providing streaming media applications. Accordingly, there is a need for methods to address quality of service (QoS) concerns of streaming media applications within networked environments.

### SUMMARY OF THE INVENTION

This invention provides methods for delivering streaming data to subscribing clients with high quality of service. The methodologies reduce problems associated with public network usage that otherwise impede efficient data subscription services.

In an embodiment, a method provides a subscription media server connected to at least two computer networks and including a data compression software algorithm that is variable according to a data transfer rate of a network connection. Media data are transferred to the media server along a first computer network and compressed according to a data transfer rate of a connection to a second network. The compression is characterized by preparing the media data to be displayed contemporaneously by a client computer during a transfer of the media data to the client computer.

The compressed data are then transferred along the second network to a client computer connected to the second network. The media server may be monitored over the first computer network.

In an alternate embodiment, a method distributes at least one subscription media server over a computer network, with the data server being connectable to an open, public portion of the network and a private portion of the network. Data are then transferred along the public portion of the network to the at least one media server and aggregated there. On command, data are transferred from the at least one media server to a client computer along the private portion of the network. The transferred data are in a form to be displayable on the client computer contemporaneous with the transferring along the private portion of the network and may have been compressed before the transfer according to a data transfer rate of the private portion of the network. The server may also be monitored over the public portion of the network according to this embodiment.

In another embodiment, a method distributes at least one subscription media server over a computer network, with the data server being connectable to a private portion of the network and isolated from an open, public portion of the network. Data are then transferred along the public portion of the network to the at least one media server and aggregated there. On command, data are transferred from the at least one media server to a client computer along the private portion of the network. The transferred data are in a form to be displayable on the client computer contemporaneous with the transferring along the private portion of the network and may have been compressed before the transfer according to a data transfer rate of the private portion of the network. The server may also be monitored over the public portion of the network according to this embodiment.

A further embodiment provides streaming media data over a computer network by a process that entails placing media data files on a staging server connected to a private computer network, associating media data files on the staging server with a permissible client distribution list and publishing the media data files to a media server connected to a open, public computer network. The media server then receives a request for a media data file over the public computer network, verifies the request according to the distribution list and transfers media data from a media server to a verified client computer over the public computer network. According to the method, the transferred data is prepared in a form displayable on the client computer in a manner contemporaneous with the transferring of data along the public computer network.

Yet another embodiment provides streaming media data over a computer network by placing media data files on a staging server connected to a first private computer network, associating the media data files on the staging server with a permissible client distribution list, publishing the media data files to a media server connected to a open, public computer network and copying media data files according to the client distribution list to a second server connected to the open, public computer network and a second private computer network. The second server may also receive third-party channel media data over the open, public computer network. Then, following a request for a media data file over the second private computer network, media data are transferred from the second server to a client computer over the second private computer network. The transferred data is in a form to be displayable on the client computer contemporaneous with the transferring of data along the second private computer network.

An additional embodiment provides streaming media data over a computer network by placing media data files on a staging server connected to a first private computer network, associating the media data files on the staging server with a permissible client distribution list, publishing the media data files to a media server connected to a open, public computer network, copying media data files according to the client distribution list to a second server connected to the open, public computer network and a second private computer network and also copying a portion of the media data files to at least one sub-net server connected to a local portion of the second private computer network. The second server may also receive third-party channel media data over the open, public computer network. Then, following a request for a media data file over the second private computer network, a selected a sub-net server responds to the request according to an origin of the request; transferring media data from the sub-net server to a client computer along a local sub-net portion of the second private computer network. The transferred data is in a form displayable on the client computer contemporaneous with the transferring of data along the portion of the second private computer network.

### BRIEF DESCRIPTION OF THE FIGURES

FIG. 1 illustrates a general overview of a computing environment.

FIG. 2 illustrates an exemplary embodiment of a network environment.

FIG. 3 illustrates problems associated with related art methodologies.

FIG. 4 illustrates an embodiment serving via the open Internet from the service provider's NOC.

FIG. 5 illustrates an embodiment serving via media servers in the client's NOC.

FIG. 6 illustrates an embodiment serving via local sub-net media servers.

FIG. 7 illustrates an embodiment serving via media servers in the client's NOC and channel partners.

FIG. 8 illustrates an embodiment serving via local sub-net media servers and channel partners.

FIG. 9 illustrates flow charts for several embodiments.

### DETAILED DESCRIPTION

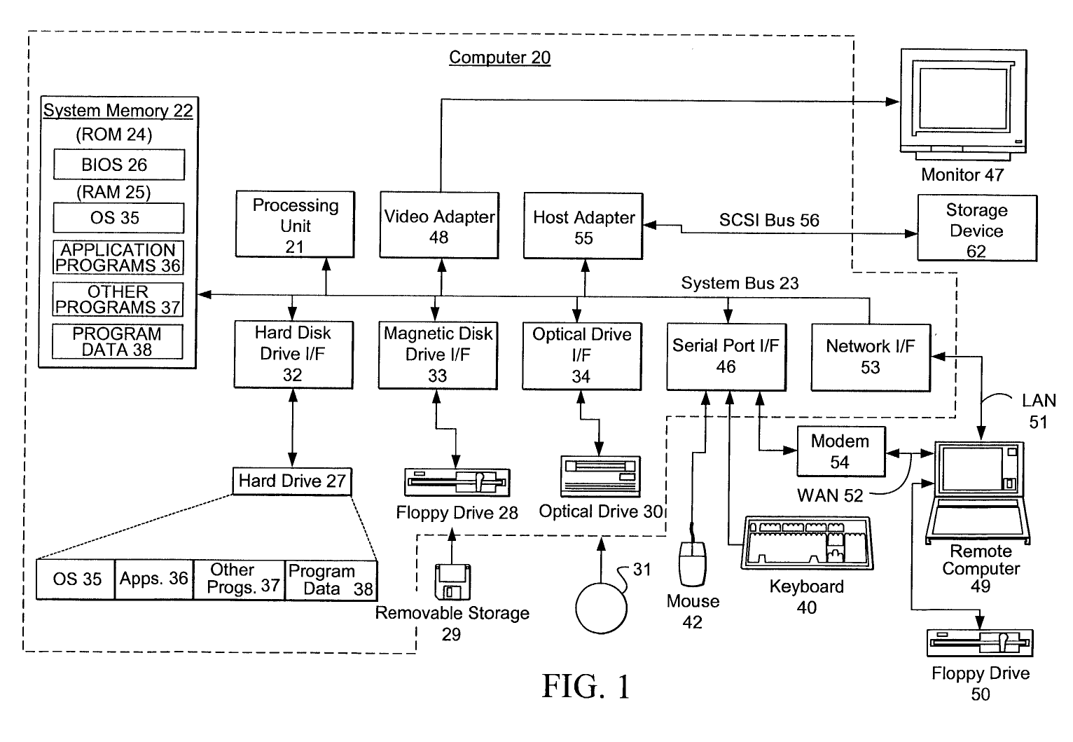

FIG. 1 and the following description are intended to provide a general description of a suitable computing environment in which the invention may be implemented. Although not necessarily required, the invention will be described in the general context of computer-executable instructions, such as program modules, being executed by a computer, such as a client workstation or a server. Generally, program modules include routines, programs, objects, components, data structures and the like that perform particular tasks or implement particular abstract data types. Moreover, those skilled in the art will appreciate that the invention may be practiced with other computer system configurations, including hand-held devices, multiprocessor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system may include a conventional personal computer 20 or the like, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory 22 may include read-only memory (ROM) 24 and random access memory (RAM) 25. A basic input/output system 26 (BIOS), containing the basic routines that help to transfer information between elements within the personal computer 20, such as during start-up, may be stored in ROM 24. The personal computer 20 may further include a hard disk drive 27 for reading from and writing to a hard disk (not shown), a magnetic disk drive 28 for reading from or writing to a removable magnetic disk 29, and an optical disk drive 30 for reading from or writing to a removable optical disk 31 such as a CD-ROM or other optical media. The hard disk drive 27, magnetic disk drive 28, and optical disk drive 30 may be connected to the system bus 23 by a hard disk drive interface 32, a magnetic disk drive interface 33, and an optical drive interface 34, respectively. The drives and their associated computer-readable media provide non-volatile storage of computer readable instructions, data structures, program modules and other data for the personal computer 20. Although the exemplary embodiment described herein may employ a hard disk, a removable magnetic disk 29, and a removable optical disk 31, or combination therefor, it should be appreciated by those skilled in the art that other types of computer readable media which can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk, magnetic disk 29, optical disk 31, ROM 24 or RAM 25, including an operating system 35, one or more application programs 36, other program modules 37 and program data 38. A user may enter commands and information into the personal computer 20 through input devices such as a keyboard 40 and pointing device 42. Other input devices (not shown) may include a microphone, joystick, game pad, satellite disk, scanner, or the like. These and other input devices are often connected to the processing unit 21 through a serial port interface 46 that is coupled to the system bus 23, but may be connected by other interfaces, such as a parallel port, game port, or universal serial bus (USB). A monitor 47 or other type of display device may also be connected to the system bus 23 via an interface, such as a video adapter 48. In addition to the monitor 47, personal computers may typically include other peripheral output devices (not shown), such as speakers and printers.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets, and the Internet.

When used in a LAN networking environment, the personal computer 20 is connected to the LAN 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

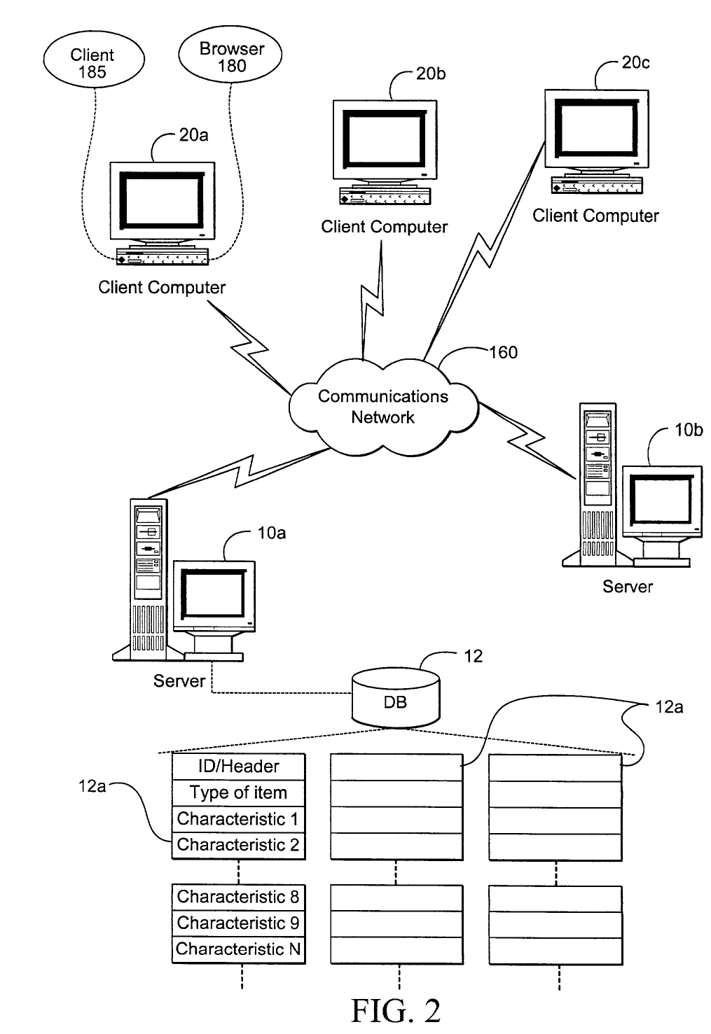

As noted, the computer described above can be deployed as part of a computer network. In general, the above description applies to both server computers and client computers deployed in a network environment. FIG. 2 illustrates one such exemplary network environment in which the present invention may be employed. As shown in FIG. 2, a number of servers 10a, 10b, etc., are interconnected via a communications network 160 (which may be a LAN, WAN, intranet or the Internet) with a number of client computers 20a, 20b, 20c, etc. In a network environment in which the communications network 160 is, e.g., the Internet, the servers 10 can be Web servers with which the clients 20 communicate via any of a number of known protocols such as, for instance, hypertext transfer protocol (HTTP). Each client computer 20 can be equipped with a browser 180 to gain access to the servers 10, and client application software 185. As shown in the embodiment of FIG. 2, server 10a includes or is coupled to a dynamic database 12.

As shown, the database 12 may include database fields 12a, which contain information about items stored in the database 12. For instance, the database fields 12a can be structured in the database in a variety of ways. The fields 12a could be structured using linked lists, multidimensional data arrays, hash tables, or the like. This is generally a design choice based on ease of implementation, amount of free memory, the characteristics of the data to be stored, whether the database is likely to be written to frequently or instead is likely to be mostly read from, and the like. A generic field 12a is depicted on the left side. As shown, a field generally has sub-fields that contain various types of information associated with the field, such as an ID or header sub-field, type of item sub-field, sub-fields containing characteristics, and so on. These database fields 12a are shown for illustrative purposes only, and as mentioned, the particular implementation of data storage in a database can vary widely according to preference.

Thus, the present invention can be utilized in a computer network environment having client computers for accessing and interacting with the network and a server computer for interacting with client computers and communicating with a database with stored inventory fields. Likewise, the streaming media process of the present invention can be implemented with a variety of network-based architectures, and thus should not be limited to the examples shown.

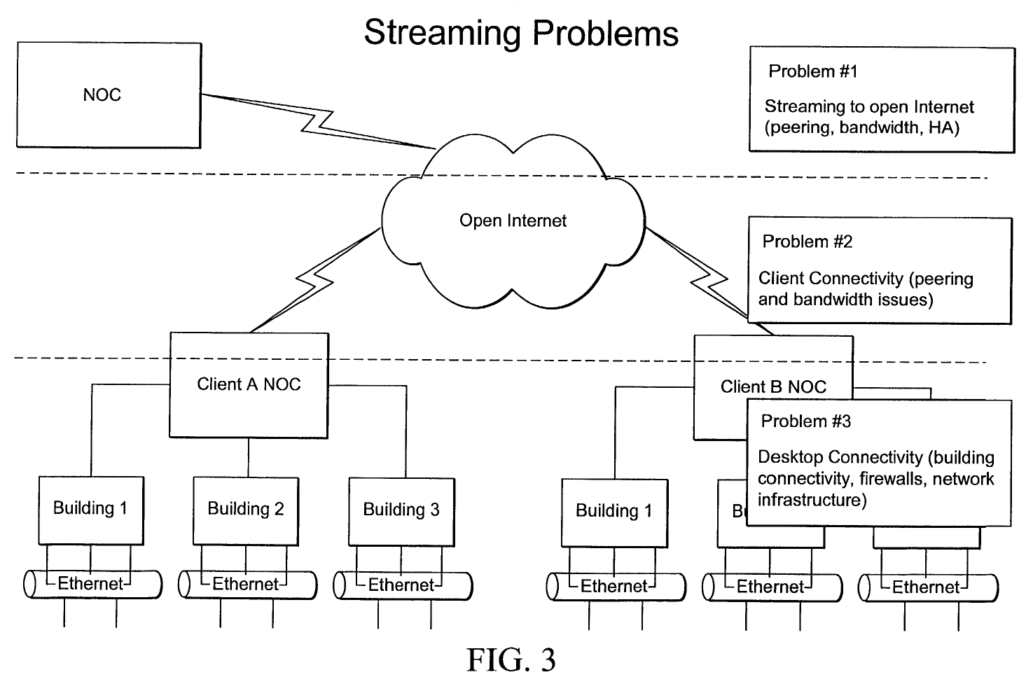

FIG. 3 illustrates some typical problems of the prior art, including bandwidth and connectivity problems. As mentioned above, previous IP video technology required that viewers first download a segment in its entirety before playback could begin. The present invention provides an out-sourced solution to such problems for data streaming and is described below with reference to preferred embodiments.

In an embodiment, the present invention eliminates downloading a segment in its entirety before playback begins by compressing the data for streaming delivery over varied bandwidth connections (e.g., low-bandwidth connections). Commercially available software such as Real Network Real Video, or Microsoft Windows Media or Apple Quicktime/Sorenson or MPEG codecs may be used for the compression. When compressed, up-to-the-minute information can be deployed to globally dispersed online audiences with quality and performance. End-users can immediately view and interact with streaming video using a computer equipped with minimum capabilities.

The present invention, using well-known commercial client/server streaming applications (such as, for example, Real Networks Real Server or Microsoft Windows Media Server or Apple Darwin Quicktime Streaming Server), provides quality Internet video broadcasts. In one embodiment, live or pre-recorded analog video feed is captured, edited, and encoded at which point it is uploaded on streaming-enabled servers (NOC). Depending on the scenario, the content is either made available “live” or archived for on-demand viewing. End users simply access a user interface and log onto the streaming media system with a password and the video is available for interaction. In one embodiment, the video or streaming media, which is embedded in a customized GUI and augmented with other forms of media, is streamed as a continuous file and can be delivered over low bandwidths (28.8K and 56K dial-up modems). No content is downloaded to the end user's hard drive. Content resides on our distribution servers and is decoded as it is received at the client PC, using a small one-time downloadable or provided plugin (e.g. Windows Media Player, RealPlayer). Streaming involves no special network requirements and minimum end-user system requirements. Because it is highly scalable, it is greatly enhanced by the multimedia capabilities of more powerful machines operating at higher bandwidths (ISDN, T-1, T-3, ADSL, cable).

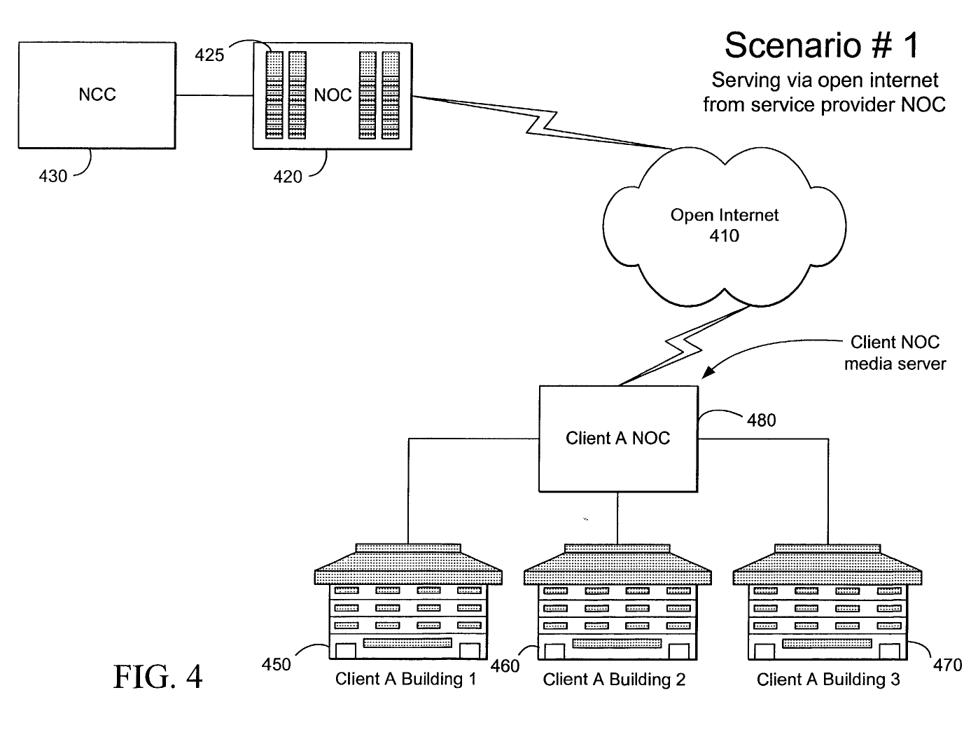

FIG. 4 illustrates a first scenario for use of the invention involving serving client media via the open, public Internet 410 from servers located in a service provider's private Network Operations Center (NOC) 420. Inside the service provider's Network Control Center (NCC) 430, personnel create and publish media files on a staging server, which resides in the service provider's NCC. After the files are created and placed on the staging server, personnel then use a content distribution tool (such as, for example, Interwoven OpenDeploy or Vignette Syndication Server) to categorize the files according to client, and client subgroups (for example, departments, buildings, etc). After categorization is complete, the service provider personnel use the content distribution tool to schedule publishing of the files, be it either immediate or at some future time. The files are then published (copied) to media servers 425 in the service provider's Operations Center and are then available for viewing at client locations 450-480 via the open, public Internet. Inside the NOC 420, the media servers may be monitored for system health, file system integrity and security from monitoring machines in the service provider's NCC.

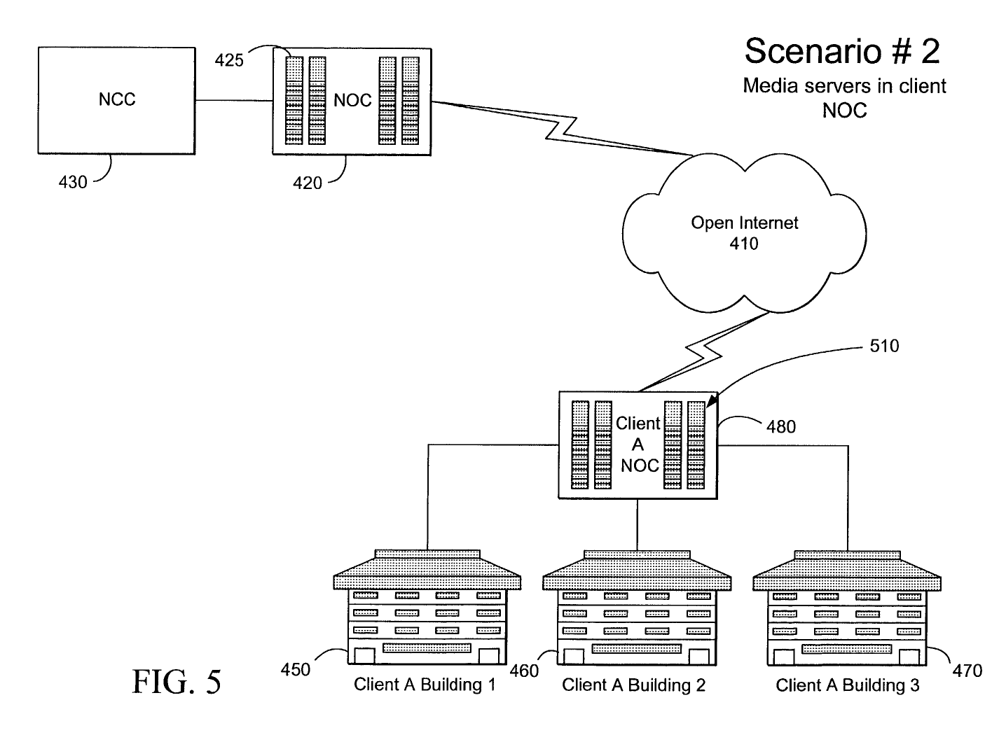

FIG. 5 illustrate a second scenario for use of the invention involving serving client media from service provider's servers 510 located in the client's Network Operations Center (NOC) 480 to overcome latency and packet-loss problems present when trying to view media files over the open Internet 410. The servers are installed in the client's NOC 480 in accordance with the client's security requirements. After installation, the flow of information is fairly similar to the first scenario, above. Inside the service provider's Network Control Center (NCC) 430, service provider personnel create and publish media files on a staging server, which resides in the service provider's NCC. After the files are created and placed on the staging server, personnel then use a standard content distribution tool to categorize the files according to client, and client subgroups (for example, departments, buildings, etc). After categorization is complete, the service provider personnel use the content distribution tool to schedule publishing of the files, be it either immediate or at some future time. The files are then published (copied) to media servers 425 in the service provider's Network Operations Center for any client employees who still need to view the files via the open Internet. In one embodiment, the files are also published to the service provider's servers 510 located in the client NOC 480 and are then available for client viewing directly from the servers in the client's NOC. Inside the client and service provider's respective NOCs, the service provider's servers may be monitored for system health, file system integrity and security from monitoring machines in the service provider's NCC in accordance with the client's established security policy.

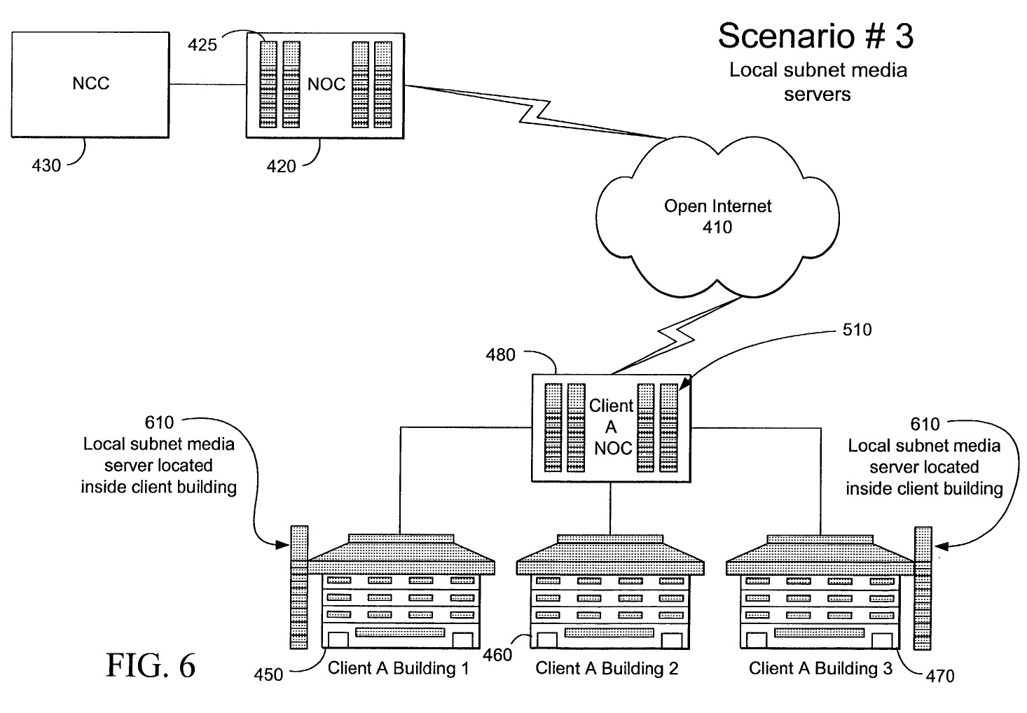

FIG. 6 illustrates a third scenario for use of the invention involving serving client media from service provider's servers located in the client's local area networks (LAN) on sub-networks. Under this scenario, the content delivery overcomes latency and packet-loss problems present when trying to view media files over the open, public Internet 410 as well as congested network links inside the client's private network. The servers are installed on the client's LAN in accordance with the client's security requirements. After installation, the flow of information is similar to the second scenario, above, except that in this case the local media servers 610 are placed in the buildings and local sub-nets where end-users are located. Inside the service provider's Network Control Center (NCC), personnel create and publish media files on a staging server residing in the service provider's NCC. After the files are created and placed on the staging server, personnel then use a standard content distribution tool (as exemplified above) to categorize the files according to client, and client subgroups (for example, departments, buildings, etc). After categorization is complete, personnel use the content distribution tool to schedule publishing of the files be it either immediate or at some future time. The files are then published (copied) to media servers in the service provider's Network Operations Center for any client employees who still need to view the files via the open Internet. The files are also published to the service provider's servers located in the client's NOC, and media servers located on the client's local subnets where the target audience resides. The content is then available for client viewing directly from the servers located closest to the client (be it the servers on their subnet or the servers in the client's NOC). Inside the client and service provider's NOC and client sub-nets, servers are monitored for system health, file system integrity and security from monitoring machines in the service provider's NCC in accordance with the client's established security policy.

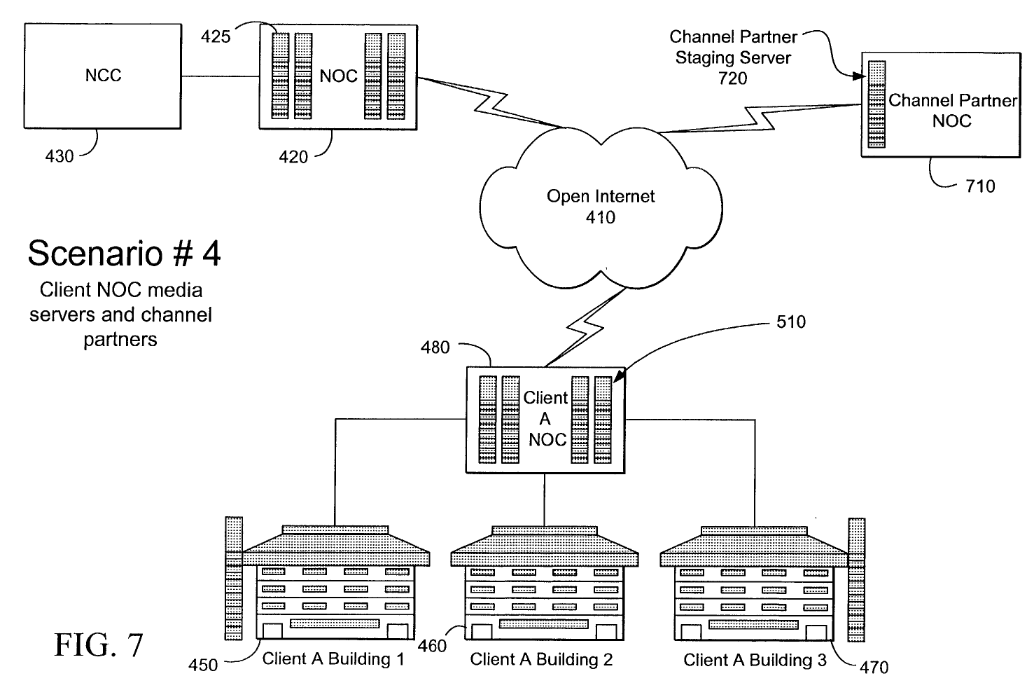

FIG. 7 illustrates a fourth scenario for use of the invention involving serving client media created by channel partners from service provider's servers located in the client's Network Operations Center 480. This overcomes latency and packet-loss problems present when trying to view media files over the open Internet. The servers are installed in the client's NOC in accordance with the client's security requirements. After installation, the flow of information is similar to the second scenario, above, except that in this case the media isn't coming from the service provider or client, but rather from Channel Partners who wish to get their media into the client's networks with good quality of service. Inside the Channel Partner's Network Control Center (NCC) 710, personnel create and publish media files on a staging server, which resides in the Channel Partner's NOC. After the files are created and placed on the staging server 720, personnel then use a standard content distribution tool to categorize the files according to client, and client subgroups (for example, departments, buildings, etc). After categorization is complete, Channel Partner personnel use the content distribution tool to schedule publishing of the files be it either immediate or at some future time. The files are then published (copied) to media servers 425 in the service provider's Network Operations Center 420 for any client employees who still need to view the files via the open Internet. The files are also published to the service provider's servers 510 located in the client NOC 480. The content is then available for client viewing directly from the servers located in the client NOC. Inside the client's and service provider's respective NOCs, the servers may be monitored for system health, file system integrity and security from monitoring machines in the service provider's NCC in accordance with the client's established security policy.

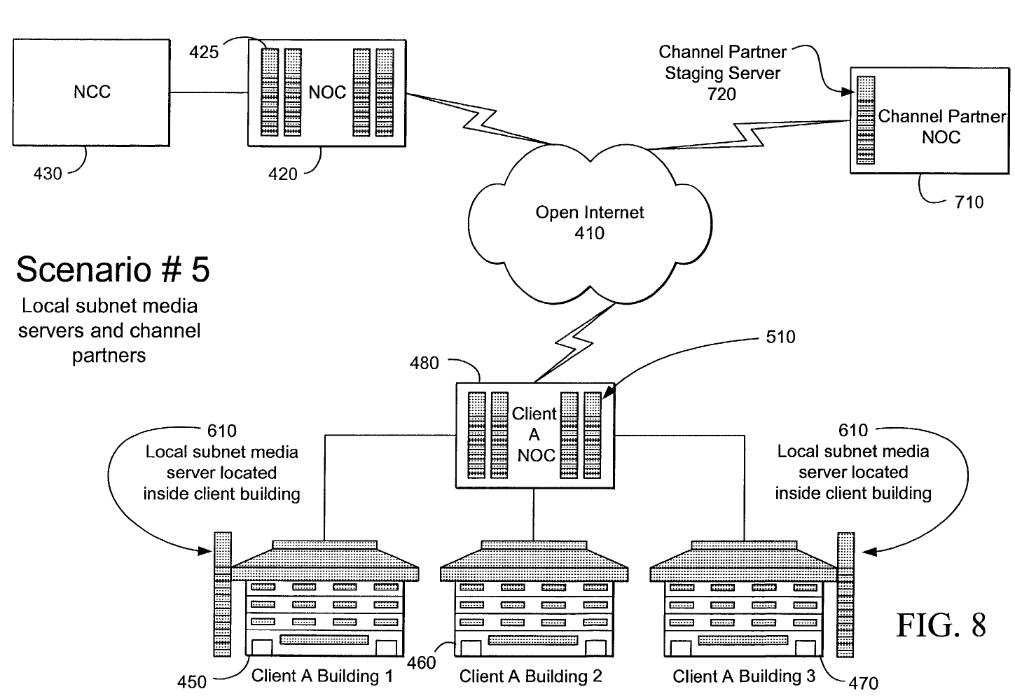

FIG. 8 illustrates a fifth scenario for use of the invention involving serving client media created by channel partners from service provider's servers located in the client's local area networks (LAN) on sub-nets. In this scenario, the content is to be delivered to overcome latency and packet loss problems that are present when trying to view media files over the open, public Internet as well as congested network links inside the client's private network. The servers are installed on the client's LAN in accordance with the client's security requirements. After installation, the flow of information is similar to the third scenario, above, except that in this case the media isn't coming from the service provider or client, but rather from Channel Partners who wish to get their media into the client's networks with good quality of service. Inside the Channel Partner Network Control Center (NCC), media files are created and published on a staging server, which resides in the Channel Partner's NOC. After the files are created and placed on the staging server, Channel Partner personnel then use a standard content distribution tool (as exemplified above) to categorize the files according to client, and client subgroups (for example, departments, buildings, etc). After categorization is complete, Channel Partner personnel uses the content distribution tool to schedule publishing of the files be it either immediate or at some future time. The files are then published (copied) to media servers in the service provider's Network Operations Center for any client employees who still need to view the files via the open Internet. The files are also published to the service provider's servers located in the client's NOC, and media servers located on the client's local sub-nets where the target audience of end-users resides. The content is then available for client viewing directly from the servers located closest to the client (be it the servers on their sub-net or the servers in the client NOC). Inside the client and service provider's respective NOCs and client sub-nets, servers are monitored for system health, file system integrity and security from monitoring machines in the service provider's NCC in accordance with the client's established security policy.

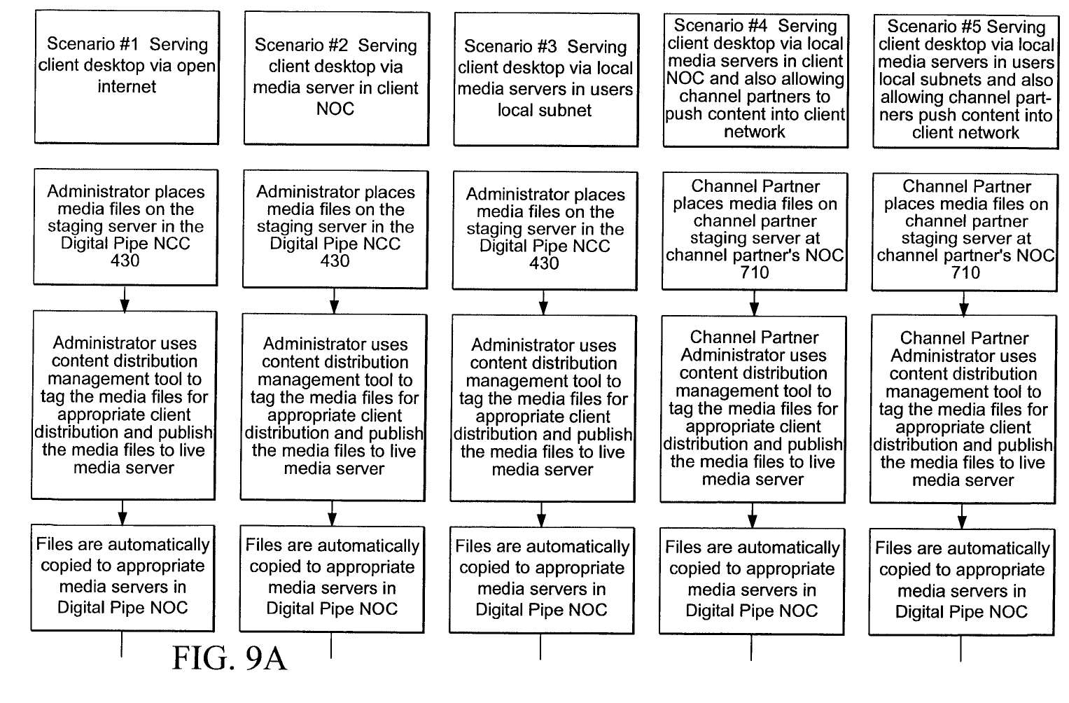

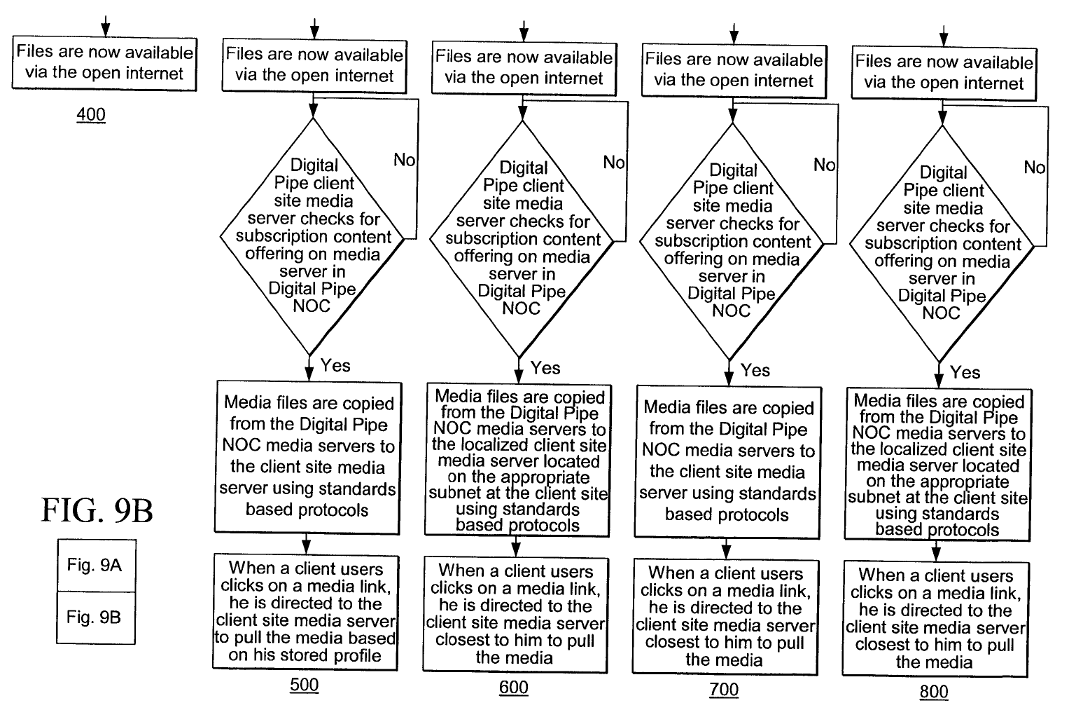

FIG. 9 shows flow charts, 400-800, corresponding to the five illustrative embodiments described above in reference to FIGS. 4-8.

The foregoing description of preferred embodiments of the invention has been presented for the purposes of illustration and description. It is not meant to be exhaustive or to limit the invention to the precise forms disclosed since many modifications and variations will be apparent to those skilled in this art. Rather, it is intended that the following claims and their equivalents define the scope of the invention.

I claim:

1. A method for delivering data over coupled computer networks, comprising:
providing a subscription media server including a data compression software algorithm, wherein the media server is connected to at least two computer networks and the data compression software algorithm is variable according to a data transfer rate of a network connection;
transferring media data to the media server along a first computer network;
compressing the media data according to a data transfer rate of a connection to a second network, wherein compressing the media data is characterized by preparing the media data to be displayed contemporaneously by a client computer during a transfer of the media data to the client computer;
transferring compressed media data along the second network to a client computer connected to the second network; and
monitoring the media server over the first computer network.

2. A method for delivering data over coupled computer networks, comprising:
distributing at least one subscription media server over a computer network, wherein the data server is connectable to an open, public portion of the network and a private portion of the network;
transferring data along the public portion of the network to the at least one media server;
aggregating data on the at least one data server;
transferring data from the at least one media server to a client computer along the private portion of the network, wherein the transferred data is displayable on the client computer contemporaneous with the transferring along the private portion of the network; and
monitoring the server over the public portion of the network.

3. The method of claim 2, further comprising compressing the media data according to a data transfer rate of the private portion of the network.

4. A method for providing delivery of data over coupled computer networks, comprising:
distributing at least one subscription media server over a computer network, wherein the data server is connectable to a private portion of the network and isolated from an open, public portion of the network;
transferring data along the public potion of the network to the at least one media server;
aggregating data on the at least one data server;
transferring data from the at least one media server to a client computer along the private portion of the network; wherein the transferred data is displayable on the client computer contemporaneous with the transferring along the private portion of the network; and
monitoring the server over the public portion of the network.

5. The method of claim 4, further comprising compressing the media data according to a data transfer rate of the private portion of the network.

6. A method for providing streaming media data over a computer network, comprising:
placing media data files on a staging server connected to a private computer network; associated media data files on the staging server with a permissible client distribution list; and
publishing the media data files to a media server connected to a open, public computer network;
receiving a request for a media data file over the public computer network;
verifying the request according to the distribution list; and
transferring media data from a media server to a verified client computer over the public computer network, wherein the transferred data is displayable on the client computer contemporaneous with the transferring of data along the public computer network.

7. A method for providing streaming media data over a computer network, comprising:
placing media data files on a staging server connected to a first private computer network;
associating the media data files on the staging server with a permissible client distribution list;
publishing the media data files to a media server connected to a open, public computer network;
copying media data files according to the client distribution list to a second server connected to the open, public computer network and a second private computer network;
receiving a request for a media data file over the second private computer network; and
transferring media data from the second server to a client computer over the second private computer network, wherein the transferred data is displayable on the client computer contemporaneous with the transferring of data along the second private computer network.

8. The method of claim 7, further comprising receiving third-party channel media data at the second server over the open, public computer network.

9. A method for providing streaming media data over a computer network, comprising:
placing media data files on a staging server connected to a first private computer network;
associating the media data files on the staging server with a permissible client distribution list;
publishing the media data files to a media server connected to a open, public computer network;
copying media data files according to the client distribution list to a second server connected to the open, public computer network and a second private computer network;
copying a portion of the media data files to at least one sub-net server connected to a local portion of the second private computer network;
receiving a request for a media data file over the second private computer network;
determining a sub-net server to respond to the request according to an origin of the request; and
transferring media data from the sub-net server to a client computer along a local sub-net portion of the second private computer network, wherein the transferred data is displayable on the client computer contemporaneous with the transferring of data along the portion of the second private computer network.

10. The method of claim 9, further comprising receiving third-party channel media data at the second server over the open, public computer network.
